(19) United States
(12) Patent Application Publication
(10) Pub. No.: US 2008/0229820 A1
(43) Pub. Date: Sep. 25, 2008

(54) Capacitive Gauge

(76) Inventor: Volodia Naydenov, Louvain-La-Neuve (BG)

Correspondence Address: Solvay North America, LLC;c/o Kim Manson, Esq., 4500 McGinnis Ferry Road, Alpharetta, GA, 30005, US

(21) Appl. No.: 12/091,089

(22) PCT Filed: Oct. 24, 2006
(86) PCT No.: PCT/EP2006/067689

§ 371 Date: Apr. 22, 2008

(30) Foreign Application Priority Data
Oct. 26, 2005 (FR) 0510932
Oct. 26, 2005 (FR) 0510933

(51) Int. Cl. G01F 23/26

(52) U.S. Cl. 73/304 C

(57) ABSTRACT

Capacitive gauge comprising a measurement capacitor, a reference capacitor and a standard capacitor, supplied by and connected to an electronic interpretation circuit comprising switches for charging and discharging the capacitors at a certain frequency; an integrator to which the charges of the measurement or reference capacitor can be transmitted and accumulated before being discharged into the standard capacitor; a comparator for comparing an output value of the integrator with a threshold value; a counter; and a processor or computation unit for calculating the level of liquid in a tank according to the equation:

h=[n_{ref,empty}/(n_{ref}-n_{ref,empty})]·[(nₘₑₐₛ-n_{meas,empty})/n_{meas,empty}],

where n are the values read by the counter respectively for the capacitance of the reference capacitor when empty (n_{ref,empty}), for the capacitance of the reference capacitor immersed in the fuel (n_{ref}), for the capacitance of the measurement capacitor when empty (n_{meas,empty}) and for the capacitance of the measurement capacitor in the liquid to be measured (nₘₑₐₛ), the counter being a timer for measuring the time elapsed between two successive overshoots of the threshold value.

The present invention relates to a capacitive gauge with an electronic circuit using the charge transfer method, and its use as a level gauge in a fuel tank.

Numerous devices have been proposed to date for measuring the level of liquid in tanks, and in particular, in fuel tanks of motor vehicles. These known devices normally use level sensors or gauges delivering a signal representative of the level of fuel in the tank.

Some of these level sensors or gauges comprise a measurement capacitor intended to be placed over the entire height of the tank and designed for its capacitance to vary reproducibly with the level of liquid in the tank, and a reference capacitor intended to be positioned in the bottom of the tank so as to be always immersed.

Thus, application WO 01/02817 discloses such a gauge in which the measurement and reference capacitors are supplied by and connected to an electronic interpretation circuit comprising switches for charging and discharging the capacitors at a certain frequency, and an integrator, a comparator and a counter. On each charge, the capacitor (measurement or reference) is raised to a given potential (V), from which there results a given charge (Q=V.Cₘₑₐₛ where Cₘₑₐₛ is the capacitance of the measurement capacitor). This charge is transferred to the integrator, an output value of which is compared to a predetermined threshold value. As long as the output value of the integrator remains less than the threshold value, the integrator continues to receive, via the capacitor (measurement or reference), a charge Q=V.Cₘₑₐₛ on each charge. When the threshold value is exceeded, the integrator is discharged into a standard capacitor, raised to the same potential (V) and the cycle recommences. A counter counts the number of times when the threshold is exceeded during a given measurement period, or n. This number is proportional to the capacitance that is measured (measurement or reference capacitance). Now, this capacitance is itself either proportional to the level of liquid in the tank (measurement capacitance), or depends on the nature of the liquid (reference capacitance), except for said capacitance “when empty”. The following relation is finally obtained:

h=[n_{ref,empty}/(n_{ref}-n_{ref,empty})]·[(nₘₑₐₛ-n_{meas,empty})/n_{meas,empty}],

where n are the values read by the counter respectively for the capacitance of the reference capacitor when empty (n_{ref,empty}), for the capacitance of the reference capacitor immersed in the fuel (n_{ref} ), for the capacitance of the measurement capacitor when empty (n_{meas,empty}) and for the capacitance of the measurement capacitor (nₘₑₐₛ), and this for a given measurement period (for more details, see the patent concerned, the teaching of which in this regard is incorporated for reference in the present application).

The drawback of this gauge lies in the fact that the response time is relatively long (typically greater than one second) as it is necessary to have a large number of threshold overshoots (and therefore a long measurement period) in order for the precision of the measurement to be good. Now, the instantaneous value of the liquid level is used in certain systems to close off the filling valve of the tank above a certain fill level. Thus, if the filling is too rapid, this level runs the risk of being exceeded. It may also prove beneficial to use a “dynamic” measurement of the change in the liquid level in a tank for experimental purposes (for example to study the effectiveness of certain geometries in terms of fill rate).

The present application seeks to solve this problem by providing a capacitive gauge with a much shorter response time, which can be used to follow the variation in the liquid level during periods of rapid change of the latter.

To this end, the present invention relates to a capacitive gauge comprising a measurement capacitor, a reference capacitor and a standard capacitor, supplied by and connected to an electronic interpretation circuit comprising switches for charging and discharging the capacitors at a certain frequency; an integrator to which the charges of the measurement or reference capacitor can be transmitted and accumulated before being discharged into the standard capacitor; a comparator for comparing an output value of the integrator with a threshold value; a counter; and a processor or computation unit for calculating the level of liquid in a tank according to the equation:

h=[n_{ref,empty}/(n_{ref}-n_{ref,empty})]·[(nₘₑₐₛ-n_{meas,empty})/n_{meas,empty}],

where n are the values read by the counter respectively for the capacitance of the reference capacitor when empty (n_{ref,empty}), for the capacitance of the reference capacitor immersed in the fuel (n_{ref}), for the capacitance of the measurement capacitor when empty (n_{meas,empty}) and for the capacitance of the measurement capacitor in the liquid to be measured (nₘₑₐₛ), the counter being a timer for measuring the time elapsed between two successive overshoots of the threshold value.

This gauge is therefore differs therefore from that of the above-mentioned prior art by the fact that the counter does not count the number of threshold overshoots over a given period, but only the time elapsed between two consecutive threshold overshoots. The measurement time is therefore the time between two threshold overshoots and not that covering several threshold overshoots. It is therefore appreciably shorter.

This gauge is preferably designed to operate as follows:
1. on starting a measurement, the electronic circuit provokes charging of the measurement capacitor with a given discrete charge and this by means of a correct positioning of the switches,
2. the position of the switches is modified so that the charge is transmitted to the integrator, which accumulates it,
3. the comparator compares an output value of the integrator (normally its voltage) with a threshold value (reference voltage),
4. the points 1 to 3 are repeated cyclically at a certain frequency v₁ (charge frequency) until the output value of the integrator is greater than the threshold value,
5. at this moment, the counter is engaged and the integrator is discharged through the standard capacitor,
6. the steps 1 to 3 are repeated cyclically until the threshold value is reached for a second time, at which moment the counter is stopped,
7. the steps 1 to 6 are repeated with the reference capacitor and its own standard, if appropriate,
8. the computation unit determines the value of the corresponding liquid level (h) and
9. the computation unit determines the volume (V) of fuel in the tank using a volume/level conversion table, this table being adapted to the shape of the tank.

Such a table may be compiled by calibration of the gauge by means of a series of measurements with known quantities of liquid (fuel).

The term “gauge” is intended to denote a device that supplies a signal representative of a level/volume of liquid in a fuel tank. According to the invention, this device is an integrated electronic device, that is, it includes an electronic circuit for processing (or interpreting) the signal transmitted by the measurement device, which can be used to determine the level of liquid in the tank.

The gauge according to the invention comprises a measurement capacitor intended to be placed over the entire height of the tank and designed for its capacitance to vary reproducibly with the level of liquid in the tank; a reference capacitor intended to be placed in the bottom of the tank so as to be always immersed; and a standard capacitor.

These capacitors can be of any known type. They can comprise flat or cylindrical plates, the capacitance of which is influenced by the medium present between them and this by skin effect. Alternatively and preferably, they comprise interdigitated (imbricated) electrodes which interact by interference effect, as described in U.S. Pat. No. 4,296,630. These electrodes are mounted on an insulating substrate and look like printed circuits; they can moreover be manufactured by manufacturing methods similar to those of printed circuits.

The term “interdigitated” electrodes is used to denote electrodes having the form of coils with loops in the form of mutually imbricated digits, and this is described in the abovementioned US patent.

According to a particularly advantageous variant, the gauge according to the invention comprises a pair of interdigitated measurement electrodes, and a pair of reference electrodes, also interdigitated, respectively forming the measurement capacitor and the reference capacitor. The pair of electrodes of the latter is preferably located at one end of the substrate (the one that will be placed/fixed on the bottom of the tank) so as to ensure its constant immersion in the liquid present in the tank. The relative height that it occupies in the tank is preferably low relative to that occupied by the pair of measurement electrodes, so that the latter can be present over substantially the entire height of the liquid.

In a particularly preferable way, the digits of the electrodes of the measurement capacitor extend vertically when the gauge is placed in the tank so as to obtain a signal that is substantially linear according to the level of liquid to be measured. Preferably, the loops of the measurement electrode and of the reference electrode are both vertical when the gauge is placed in the tank. Furthermore, they advantageously have at least one electrode partly in common.

The electrical connections between the electrodes of the capacitors according to this variant of the invention and the electronic interpretation circuit are preferably covered by the insulating substrate so as not to disturb the measurement.

As for the standard capacitances, these are components located on a printed circuit including the measurement capacitance and the reference capacitance.

According to one particularly advantageous variant, the gauge according to the invention comprises two standard capacitors—one specific to measuring the capacitance of the measurement capacitor and one specific to measuring the capacitance of the reference capacitor—so as to improve the precision of the measurement. It has in fact been observed that this precision is increased when the capacitance of the capacitor to be measured approaches the capacitance of the standard capacitor through which it is discharged, while still remaining below the latter. Since the capacitance of the reference capacitor is considerably smaller than the capacitance of the measurement capacitor, it is therefore advantageous to discharge it into a standard capacitor of also smaller capacitance (typically around 50 pF compared with around 500 pF in the case of the standard capacitance of the measurement capacitor). The capacitance of the standard capacitor for discharging the reference capacitor may vary from 10 to 500 pF. The capacitance of the standard capacitor for discharging the measurement capacitor may vary from 100 to 5000 pF.

According to an advantageous variant of the invention, the counting frequency v₂ is greater than the charge frequency v₁ and this with a view to increasing the resolution of the gauge. Typically, v₁ is measured in hundreds of kHz whereas v₂ is measured in tens of MHz.

As an example, with the system described in the abovementioned PCT application, the measurement period is typically of the order of 600 ms, a period during which the counter has counted approximately 2500 threshold overshoots and during which the integrator has received 600 ms/100 kHz=0.6×10⁵=60000 charges. This results in a period between two threshold overshoots of 600/2500=240 μs, period during which the integrator has received 60000/2500=24 charges. If, according to the invention, the same charge system is used but, after the first threshold overshoot, a counter (chronometer) is engaged which works at a frequency of approximately 10 MHz (or 0.1 μs between two “pulses”), there is obtained over the period between two threshold overshoots (which remains 240 μs), 240/0.1=2400 beats on the counter. There is therefore obtained at least a similar resolution (2400 compared to 2500 beats on the counter), since the various charge increments on the integrator are not truly discontinuous and there are many of them (the trend of the output value on the integrator as a function of time being a function having the form of a staircase with 24 small oblique treads, therefore tending in reality towards a straight line). However, the measurement period is significantly shorter (measured in μs instead of ms), hence a significantly better gauge response time.

The gauge according to the invention is preferably linked to a device for displaying the level value calculated by the computation unit.

Preferably, the gauge according to the invention is designed to be able to operate permanently when powered by electric current. To this end, the steps 1 to 9 are repeated continuously and cyclically. After each measurement, the value calculated by the computation unit is transmitted to the display device, which holds it in memory and displays it until the next measurement.

Finally, the invention also relates to the use of a gauge as described previously as a level gauge in a fuel tank, preferably for a vehicle. It is preferably a gauge with a computation unit as described above. It preferably operates continuously as long as it is supplied with electric current, that is, preferably, as long as the engine of the vehicle is running.

1. A capacitive gauge comprising a measurement capacitor, a reference capacitor and a standard capacitor, supplied by and connected to an electronic interpretation circuit comprising switches for charging and discharging the capacitors at a certain frequency; an integrator to which the charges of the measurement or reference capacitor can be transmitted and accumulated before being discharged into the standard capacitor; a comparator for comparing an output value of the integrator with a threshold value; a counter; and a processor or computation unit for calculating the level of liquid in a tank according to the equation:
h=[n_{ref,empty}/(n_{ref}-n_{ref,empty})]·.[(nₘₑₐₛ-n_{meas,empty})/n_{meas,empty}],
where n are the values read by the counter respectively for the capacitance of the reference capacitor when empty (n_{ref,empty}), for the capacitance of the reference capacitor immersed in the fuel (n_{ref} ), for the capacitance of the measurement capacitor when empty (n_{meas,empty}) and for the capacitance of the measurement capacitor in the liquid to be measured (nₘₑₐₛ); wherein the counter is a timer for measuring the time elapsed between two successive overshoots of the threshold value.

2. The gauge according to claim 1, wherein it is designed to operate as follows:
a) on starting a measurement, the electronic circuit provokes charging of the measurement capacitor with a given discrete charge and this by means of a correct positioning of the switches,
b) the position of the switches is modified so that the charge is transmitted to the integrator, which accumulates it,
c) the comparator compares an output value of the integrator (normally its voltage) with a threshold value (reference voltage),
d) steps a to c are repeated cyclically at a certain frequency v₁ (charge frequency) until the output value of the integrator is greater than the threshold value,
e) at this moment, the counter is engaged and the integrator is discharged through the standard capacitor,
f) the steps a to c are repeated cyclically until the threshold value is reached for a second time, at which moment the counter is stopped,
g) the steps a to f are repeated with the reference capacitor and its own standard, if appropriate,
h) the computation unit determines the value of the corresponding liquid level (h),
i) the computation unit determines the volume (V) of fuel in the tank using a volume/level conversion table, this table being adapted to the shape of the tank.

3. The gauge according to any one of the preceding claim 1, wherein the capacitors comprise interdigitated (imbricated) electrodes that interact by interference effect.

4. The gauge according to claim 3, wherein the electrodes are in the form of labyrinths with loops in the form of mutually imbricated fingers, and wherein the fingers of the electrodes of the measurement capacitor lie vertically when the gauge is placed in the tank.

5. The gauge according to claim 3, wherein the interdigitated electrodes are affixed to an insulating support and wherein the electrical connections between these electrodes and the electronic interpretation circuit are encapsulated by this support.

6. The gauge according to claim 1, wherein it comprises two standard capacitors—one specific to measuring the capacitance of the measurement capacitor and one specific to measuring the capacitance of the reference capacitor.

7. The gauge according to any one of the preceding claim 1, wherein the timer operates at a frequency v₂ greater than the charge frequency v₁.

8. The gauge according to claim 1, wherein:
it is linked to a device for displaying the calculated value of the volume (V) of fuel;
it is designed to operate continuously when it is supplied by electric current; and
after each measurement, the calculated value (V) is transmitted to the display device, which holds it in memory and displays it until the next measurement.

9. A use of a gauge according to claim 1 as level gauge in a fuel tank.

10. A motor vehicle comprising the fuel tank and the gauge according to claim 8 as level gauge for this tank.
